(19) United States
(12) Patent Application Publication
(10) Pub. No.: US 2026/0272244 A1
(43) Pub. Date: Sep. 17, 2026

(54) ROBOTIC VACUUM CLEANER AND METHOD FOR CONTROLLING SAME

(71) Applicant: SAMSUNG ELECTRONICS CO., LTD., Suwon-si (KR)

(72) Inventors: Bokyung LEE, Suwon-si (KR); Taejun KWON, Suwon-si (KR); Sujin KIM, Suwon-si (KR); Sangwon AHN, Suwon-si (KR); Yunwoo LEE, Suwon-si (KR); Eunae JO, Suwon-si (KR); Seongil HAHM, Suwon-si (KR)

(73) Assignee: SAMSUNG ELECTRONICS CO., LTD., Suwon-si (KR)

(21) Appl. No.: 19/676,396

(22) Filed: May 13, 2026

Related U.S. Application Data
(63) Continuation of application No. PCT/KR2024/096404, filed on Oct. 29, 2024.

(30) Foreign Application Priority Data
Nov. 13, 2023 (KR) 10-2023-0156715

(51) Int. Cl. A47L 11/40

(52) U.S. Cl. CPC A47L 11/4011; A47L 11/4002; A47L 11/4036; A47L 11/4063; A47L 2201/04

(57) ABSTRACT

A robotic vacuum cleaner and a method for controlling the same. The robotic vacuum cleaner includes a first sensor using ultrasonic waves; at least one second sensor related to a movement of the robotic vacuum cleaner; a memory storing information on a traveling path; and a processor that: obtains first data related to a feature of a floor surface on the traveling path through the first sensor while the robotic vacuum cleaner moves along the traveling path; obtains second data related to the movement of the robotic vacuum cleaner through the at least one second sensor; obtains type information indicating the type of the floor surface by inputting a traveling data set including at least part of the first data and the second data to a trained neural network model; and controls the operation of the robotic vacuum cleaner on the basis of the type information.

### CROSS-REFERENCE TO RELATED APPLICATION

This application is a continuation application, under 35 U.S.C. § 111(a), of international application No. PCT/KR2024/096404, filed Oct. 29, 2024, which claims priority under 35 U.S. C. § 119 to Korean Patent Application No. 10-2023-0156715, filed Nov. 13, 2023, the disclosures of which are incorporated herein by reference in their entireties.

### TECHNICAL FIELD

Apparatuses and methods consistent with the disclosure relate to a robotic vacuum cleaner and a method for controlling the same, and more particularly, to a robotic vacuum cleaner capable of identifying a type of a floor surface and performing an operation corresponding to the identified type of the floor surface, and a method for controlling the same.

### BACKGROUND ART

Recently, technological advancements in robotic vacuum cleaners capable of automatically moving along a traveling path to clean floor surfaces have accelerated. In particular, the robotic vacuum cleaners capable of performing cleaning by a method appropriate to a type of a floor surface have recently been provided.

However, for the robotic vacuum cleaner to perform cleaning with high user satisfaction, it is important to accurately identify the type of the floor surface and perform cleaning using a method appropriate to the identified type of the floor surface.

Conventional technologies for detecting the type of the floor surface include using ultrasonic sensors, capturing images of the floor surface, using cliff sensors to detect the height of the robotic vacuum cleaner from the floor surface, using wheel sensors to detect changes in the speed of the robotic vacuum cleaner's wheels, etc.

However, in applying the conventional technology using ultrasonic sensors, a single ultrasonic sensor is typically disposed on the front left or front right due to space constraints caused by bulky components such as casters (small front wheels), batteries, and drum brushes, as well as for cost savings. Therefore, the conventional technology using ultrasonic sensors has limitations in that there may be areas along the traveling path where the ultrasonic sensor may not detect the type of the floor surface (as specifically described with reference to FIG. 1). In particular, carpet areas not detected by the ultrasonic sensor may become wet during wet-mode traveling, especially when a wet mop is used for cleaning.

Meanwhile, to overcome these limitations of the conventional technologies, there exist technologies that prioritize rules, such as not lifting a mop for a certain period of time even when a floor surface where carpet is not present is detected during wet-mode traveling. However, these technologies have the limitation that they can only prevent carpet from wetting when the robotic vacuum cleaner leaves a carpeted area, and it is difficult to prevent carpet from wetting when the robotic vacuum cleaner enters the carpeted area.

In addition, when identifying the type of the floor surface using only the ultrasonic sensors, the technology has the limitation that it may misclassify tatami carpets as the floor, causing the carpet to become wet during wet-mode traveling.

Meanwhile, while auxiliary sensors, such as the image sensor and the cliff sensor, may be added to complement ultrasonic sensors, these approaches incur additional costs. Furthermore, even when using the auxiliary sensors such as the image sensor and the cliff sensor, the accuracy of floor type classification is not high, and it is pointed out that the robotic vacuum cleaner may detect a carpeted area only after traveling a certain distance (approximately 15 cm) on the carpet.

### DISCLOSURE OF INVENTION

### Solution to Problem

The present disclosure is intended to overcome the limitations of the conventional technologies described above, and is to provide a robotic vacuum cleaner capable of efficiently and accurately identifying a type of a floor surface using a trained neural network model, and performing operations suitable for the identified type of the floor surface, and a method for controlling the same.

In accordance with an aspect of the disclosure, a robotic vacuum cleaner includes: a first sensor using ultrasonic waves; at least one second sensor related to a movement of the robotic vacuum cleaner; a memory storing information on a traveling path of the robotic vacuum cleaner; and a processor configured to obtain first data related to a feature of a floor surface on the traveling path through the first sensor while the robotic vacuum cleaner moves along the traveling path and obtain second data related to the movement of the robotic vacuum cleaner through the at least one second sensor, obtain type information indicating the type of the floor surface by inputting a traveling data set including at least part of the first data and the second data to a trained neural network model, and control an operation of the robotic vacuum cleaner based on the type information.

The at least one second sensor may include at least one of an acceleration sensor, an angular velocity sensor, and a wheel sensor, and the type information may include information on whether carpet is present on the floor surface along the traveling path and information on at least one of a material of the floor surface and a material of the carpet.

The processor may be configured to input only at least part of the second data among the first data and the second data to the neural network model to obtain the type information, identify the type of the floor surface based on the first data, control an operation of the robotic vacuum cleaner based on an identification result that carpet is present on the floor surface, when it is identified based on the first data that the carpet is present on the floor surface, and control the operation of the robotic vacuum cleaner based on the type information, when it is identified based on the first data that the carpet is not present on the floor surface.

The robotic vacuum cleaner may further include: at least one third sensor using infrared ray, in which the processor may be configured to obtain, through the at least one third sensor, third data related to a color of the floor surface, including information on reflectivity of the floor surface to the infrared ray, and input a traveling data set including at least part of the first data, the second data, and the third data into a trained neural network model to obtain the type information, and the traveling data set may include data related to shaking of the robotic vacuum cleaner among the second data and the third data.

The processor may include the third data in the traveling data set when a value indicating an amount of change in data related to the shaking of the robotic vacuum cleaner is greater than or equal to a first threshold value and a value indicating an amount of change in the third data is greater than or equal to a second threshold value.

The processor may be configured to transform part of the traveling data set such that the value indicating the amount of change in data related to the shaking of the robotic vacuum cleaner and the value indicating the amount of change in the third data have larger values, and input the transformed traveling data set to the neural network model to obtain the type information.

The robotic vacuum cleaner may further include: a dry brush; a wet brush; and a driving unit including at least one motor, in which the processor may be configured to control the driving unit to lift the wet brush while performing cleaning on a carpeted area on which carpet is present, when it is identified based on the type information that the carpet is present on the floor surface while performing cleaning on the floor surface using the wet brush.

The processor may be configured to control the driving unit to increase a suction force of the robotic vacuum cleaner while performing cleaning on the carpeted area, when it is identified based on the type information that the carpet is present on the floor surface while the robotic vacuum cleaner cleans the floor surface using the dry brush.

The processor may be configured to modify the information on the traveling path stored in the memory based on the type information, and control the driving unit to move the robotic vacuum cleaner based on the modified information on the traveling path.

The processor may be configured to control the driving unit to lift the wet brush while performing cleaning on a carpeted area on which a carpet of a first material is present, when it is identified based on the type information that the carpet of the first material is present on the floor surface while performing cleaning on the floor surface using the wet brush, modify the information on the traveling path stored in the memory when it is identified based on the type information that a carpet of a second material different from the first material is present on the floor surface while performing cleaning of the floor surface using the wet brush, and control the driving unit to cause the robotic vacuum cleaner to travel based on the modified information on the traveling path.

The wet brush may include a first wet brush disposed on a first side surface of the robotic vacuum cleaner and a second wet brush disposed on a second side surface different from the first side surface, and the processor may be configured to control the driving unit to lift the first wet brush and not to lift the second wet brush while performing cleaning on a composite area using the wet brush when it is identified based on the type information that there is the composite area in which the carpet is present on the floor surface corresponding to the first side and the carpet is not present on the floor surface corresponding to the second side surface.

In accordance with another aspect of the disclosure, a method for controlling a robotic vacuum cleaner includes: obtaining first data related to a feature of a floor surface on a traveling path through a first sensor using ultrasonic waves while the robotic vacuum cleaner moves along the traveling path; obtaining second data related to a movement of the robotic vacuum cleaner through at least one second sensor related to the movement of the robotic vacuum cleaner while the robotic vacuum cleaner moves along the traveling path; obtaining type information indicating the type of the floor surface by inputting a traveling data set including at least part of the first data and the second data to a trained neural network model; and controlling an operation of the robotic vacuum cleaner based on the type information.

The at least one second sensor may include at least one of an acceleration sensor, an angular velocity sensor, and a wheel sensor, and the type information may include information on whether carpet is present on the floor surface along the traveling path and information on at least one of a material of the floor surface and a material of the carpet.

The obtaining of the type information may include inputting only at least part of the second data among the first data and the second data to the neural network model to obtain the type information, and the controlling of the operation of the robotic vacuum cleaner may further include: identifying the type of the floor surface based on the first data; controlling an operation of the robotic vacuum cleaner based on an identification result that carpet is present on the floor surface, when it is identified based on the first data that the carpet is present on the floor surface; and controlling the operation of the robotic vacuum cleaner based on the type information, when it is identified based on the first data that the carpet is not present on the floor surface.

The method for controlling a robotic vacuum cleaner may further include: obtaining, through the at least one third sensor using infrared ray, third data related to a color of the floor surface, including information on reflectivity of the floor surface to the infrared ray, in which the obtaining of the type information may include inputting a traveling data set including at least part of the first data, the second data, and the third data into a trained neural network model to obtain the type information, and the traveling data set may include data related to shaking of the robotic vacuum cleaner among the second data and the third data.

The obtaining of the type information may further include incorporating the third data into the traveling data set when a value indicating the amount of change in data related to the shaking of the robotic vacuum cleaner is greater than or equal to a first threshold value and a value indicating the amount of change in the third data is greater than or equal to a second threshold value.

The obtaining of the type information may include transforming part of the traveling data set such that the value indicating the amount of change in data related to the shaking of the robotic vacuum cleaner and the value indicating the amount of change in the third data have larger values, and inputting the transformed traveling data set to the neural network model to obtain the type information.

The controlling of the operation of the robotic vacuum cleaner may include lifting the wet brush while performing cleaning on a carpeted area on which carpet is present, when it is identified based on the type information that the carpet is present on the floor surface while the robotic vacuum cleaner cleans the floor surface using the wet brush.

The controlling of the operation of the robotic vacuum cleaner may further include increasing a suction force of the robotic vacuum cleaner while performing cleaning on the carpeted area, when it is identified based on the type information that the carpet is present on the floor surface while the robotic vacuum cleaner cleans the floor surface using the dry brush.

The controlling of the operation of the robotic vacuum cleaner may further include modifying the information on the traveling path stored in the memory based on the type information and controlling the robotic vacuum cleaner to travel based on the information on the modified traveling path.

### BRIEF DESCRIPTION OF DRAWINGS

FIG. 1 is a diagram for describing an operation of a robotic vacuum cleaner according to the related art.

FIG. 2 is a block diagram schematically illustrating a configuration of the robotic vacuum cleaner according to one or more embodiments of the present disclosure.

FIG. 3 is a diagram for describing a neural network model and a plurality of modules according to one or more embodiments.

FIG. 4 is a diagram for describing one or more embodiments related to a floor surface type identification module according to the present disclosure.

FIG. 5 is a block diagram illustrating the configuration of the robotic vacuum cleaner according to one or more embodiments of the present disclosure.

FIG. 6 is a diagram for describing one or more embodiments related to a third sensor according to the present disclosure.

FIG. 7 is a diagram for describing one or more embodiments related to the location and number of third sensor.

FIG. 8 is a block diagram illustrating the configuration of the robotic vacuum cleaner according to one or more embodiments of the present disclosure.

FIG. 9 is a diagram for describing a process of controlling a wet brush according to one or more embodiments.

FIG. 10 is a flowchart illustrating a method for controlling a robotic vacuum cleaner according to one or more embodiments of the present disclosure.

### MODE FOR INVENTION

Since the present embodiments may be variously modified and have several embodiments, specific embodiments of the present disclosure will be illustrated in the drawings and be described in detail in the detailed description. However, it is to be understood that the disclosure are not limited to specific embodiments, but include all modifications, equivalents, and substitutions according to exemplary embodiments of the disclosure. Throughout the accompanying drawings, similar components will be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following embodiments may be modified in several different forms, and the scope and spirit of the disclosure are not limited to the following embodiments. Rather, these embodiments make the disclosure thorough and complete, and are provided to completely transfer the spirit of the disclosure to those skilled in the art.

Terms used in the disclosure are used only to describe specific embodiments rather than limiting the scope of the disclosure. Singular expressions are intended to include plural expressions unless the context clearly represents otherwise.

In the present disclosure, an expression “have,” “may have,” “include,” “may include,” or the like, indicates existence of a corresponding feature (for example, a numerical value, a function, an operation, a component such as a part, or the like), and does not exclude existence of an additional feature.

In the present disclosure, an expression “A or B,” “at least one of A and/or B,” “one or more of A and/or B,” or the like, may include all possible combinations of items enumerated together. For example, “A or B”, “at least one of A and B”, or “at least one of A or B” may indicate all of 1) a case in which at least one A is included, 2) a case in which at least one B is included, or 3) a case in which both of at least one A and at least one B are included.

Expressions “first,” “second,” “1st” or “2nd” or the like, used in the present disclosure may indicate various components regardless of a sequence and/or importance of the components, will be used only in order to distinguish one component from the other components, and do not limit the corresponding components.

When it is mentioned that any component (for example: a first component) is (operatively or communicatively) coupled with/to or is connected to another component (for example: a second component), it is to be understood that any component is directly coupled to another component or may be coupled to another component through the other component (for example: a third component).

On the other hand, when it is mentioned that any component (for example, a first component) is “directly coupled” or “directly connected” to another component (for example, a second component), it is to be understood that the other component (for example, a third component) is not present between any component and another component.

An expression “configured (or set) to” used in the disclosure may be replaced by an expression “suitable for,” “having the capacity to,” “designed to,” “adapted to,” “made to, or “capable of” depending on a situation. A term “~configured (or set) to” may not necessarily mean “specifically designed to” in hardware.

Instead, an expression “~an apparatus configured to” may mean that the apparatus “is capable of” together with other apparatuses or components. For example, a “processor configured (or set) to perform A, B, and C” may mean a dedicated processor (for example, an embedded processor) for performing the corresponding operations or a generic-purpose processor (for example, a central processing unit (CPU) or an application processor) that may perform the corresponding operations by executing one or more software programs stored in a memory device.

In an embodiment, a “module” or a “unit” may perform at least one function or operation, and be implemented by hardware or software or be implemented by a combination of hardware and software. In addition, a plurality of “modules” or a plurality of “~ers/ors” may be integrated in at least one module and be implemented by at least one processor except for a ‘module’ or an ‘~er/or’ that needs to be implemented by specific hardware.

Meanwhile, various elements and regions in the drawings are schematically illustrated. Therefore, the spirit of the disclosure is not limited by relatively sizes or intervals illustrated in the accompanying drawings.

Hereinafter, embodiments of the disclosure will be described in detail with reference to the accompanying drawings so that those skilled in the art to which the disclosure pertains may easily practice the disclosure.

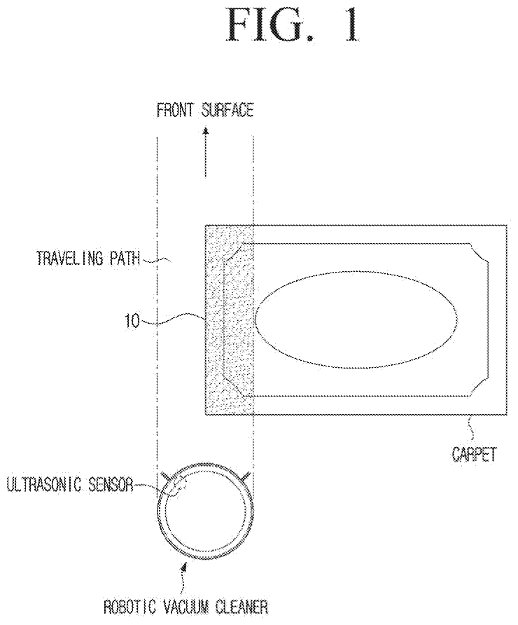

FIG. 1 is a diagram for describing an operation of a robotic vacuum cleaner according to the related art.

As illustrated in FIG. 1, a robotic vacuum cleaner according to the related art may travel heading forward along a traveling path. Furthermore, the robotic vacuum cleaner according to the related art may identify a type of a floor surface along the traveling path using a single ultrasonic sensor disposed on the front left side of the robotic vacuum cleaner.

However, since the ultrasonic sensor may detect only information on characteristics of a floor surface located directly beneath the ultrasonic sensor, it may be difficult to accurately identify the type of the floor surface on the front right side of the robotic vacuum cleaner using only the single ultrasonic sensor disposed on the front left side of the robotic vacuum cleaner.

For example, as illustrated in FIG. 1, when a carpet is present on the right side of the traveling path and is not present on the left side, the robotic vacuum cleaner according to the related art may only detect information on the characteristics of the floor surface on the left side, thereby identifying that the carpet is not present on the right side of the traveling path. In this case, when the robotic vacuum cleaner travels along the traveling path, it will not be able to perform appropriate cleaning on the carpeted area on the front right side. In particular, when traveling in wet mode using a wet mop, a carpeted area 10 on the front right side of the robotic vacuum cleaner may become wet.

In addition to the example illustrated in FIG. 1, the robotic vacuum cleaner according to the related art has a limitation in that an area that is not recognized as a carpeted area may occur at a time when the robotic vacuum cleaner leaves the carpeted area, and accordingly, an area that becomes wet due to a mop during wet-mode traveling may occur.

Furthermore, the robotic vacuum cleaner according to the related art may not perform appropriate cleaning depending on the type of the floor surface, and may wet the carpeted area, when the robotic vacuum cleaner obliquely enters or leaves the carpeted area at an angle (i.e., when one side of the robotic vacuum cleaner enters or leaves the carpeted area before the other side), when a carpet of a special material, such as a carpet of a tatami material, is present on the floor surface, or the like.

Hereinafter, various embodiments for overcoming the limitations of the related art described above will be described in detail.

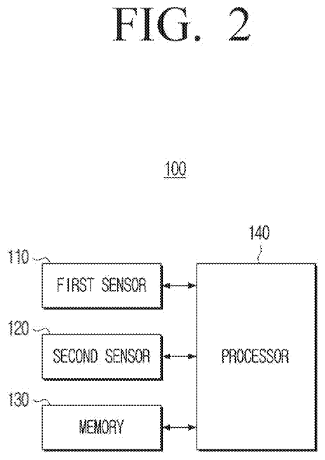

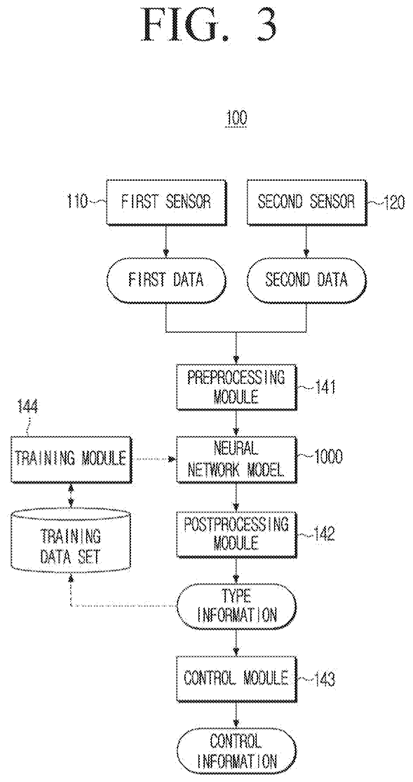

FIG. 2 is a block diagram schematically illustrating a configuration of a robotic vacuum cleaner 100 according to one or more embodiments of the present disclosure, and FIG. 3 is a diagram illustrating a neural network model 1000 and a plurality of modules according to one or more embodiments. This will be described below with reference to FIGS. 2 and 3 together.

The “robotic vacuum cleaner 100” refers to a robot-based device that automatically cleans a floor surface (i.e., a surface to be cleaned). In particular, the robotic vacuum cleaner 100 may autonomously travel along a traveling path based on data obtained through various sensors, thereby capturing (collecting) contaminants such as dust, hair, and particulates from the floor surface. The robotic vacuum cleaner 100 may be implemented in various types depending on the components included in the robotic vacuum cleaner 100 and the functions implemented through the robotic vacuum cleaner 100. However, there are no particular limitations on the type of robotic vacuum cleaner 100 according to the present disclosure.

As illustrated in FIG. 2, the robotic vacuum cleaner 100 may include a first sensor, a second sensor, a memory 130, and a processor 140.

The “first sensor” is a sensor that utilizes ultrasonic waves and may be referred to by terms such as “ultrasonic sensor.” Specifically, the first sensor may obtain data on object characteristics, distances to objects, etc., by emitting ultrasonic waves and receiving ultrasonic waves reflected by various objects disposed on the floor surface or in the cleaning space.

In particular, the first sensor according to the present disclosure may obtain first data. The first sensor may obtain first data at preset cycles (e.g., 20 ms), and the first data acquired at each cycle may represent the characteristics of the floor surface, which is a sensing target area, at the time when the first data is obtained. Here, the “sensing target area” refers to the area detected by the first sensor and refers to a portion of the front floor surface of the robotic vacuum cleaner 100. The scope of the sensing target area may be determined based on the location, number, and specifications of the first sensor.

The “first data” refers to data on the characteristics of the floor surface along the traveling path of the robotic vacuum cleaner 100, which is obtained through the first sensor, and may include at least one sensing value obtained through the first sensor. Meanwhile, the term “data” in the present disclosure may be used collectively to refer to at least one “sensing value” obtained through the sensor. The first data may consist of binary values including a value of 1 indicating that a carpet is present in the sensing target area, and a value of 0 indicating that carpet is not present in the sensing target area, i.e., that the sensing target area corresponds to a normal floor.

The first sensor may be disposed on the front left side of the robotic vacuum cleaner 100, as illustrated in FIG. 1, and the number of first sensors may be one. While there are no specific limitations on the location and number of first sensors, the description of the present disclosure assumes that only one first sensor is disposed on the front left side of the robotic vacuum cleaner 100, as illustrated in FIG. 1.

The “second sensor” refers to a sensor related to the movement of the robotic vacuum cleaner 100. There may be at least one second sensor, or a plurality of second sensors. Specifically, at least one second sensor may include at least one of an acceleration sensor, an angular velocity sensor, and a wheel sensor.

The acceleration sensor may obtain data on acceleration due to the movement of the robotic vacuum cleaner 100. Specifically, the acceleration sensor may obtain sensing values representing acceleration in the x-axis, y-axis, and z-axis directions while the robotic vacuum cleaner 100 moves. The data obtained through the acceleration sensor may be used to obtain information on the movement, stop, acceleration, deceleration, movement direction, shaking, and balance of the robotic vacuum cleaner 100.

The angular velocity sensor may obtain data on the angular velocity of the robotic vacuum cleaner 100 based on its rotational motion. The angular velocity sensor may include a gyroscope sensor. Specifically, the angular velocity sensor may obtain sensing values such as the amount of change in the rotational motion of the robotic vacuum cleaner 100 and the roll, pitch, and yaw values of the robotic vacuum cleaner 100. The data obtained through the angular velocity sensor may be used to obtain information on whether the robotic vacuum cleaner 100 is rotating, the direction of rotation, the degree of rotation, and the robot's posture, etc.

The wheel sensor may obtain data on the movement of the wheels of the robotic vacuum cleaner 100. Specifically, the wheel sensor may obtain sensing values such as linear velocity and angular velocity values indicating the rotational speed and direction of the wheel while the robotic vacuum cleaner 100 moves, values indicating the accumulated number of rotations of the wheel, and the duty value of the power transmitted to the wheel motor connected to the wheel. The data obtained through the wheel sensor may be used to obtain information on the moving direction, moving distance, and moving speed of the robotic vacuum cleaner 100.

In addition, various sensors, such as a collision sensor that detects impact caused by the robotic vacuum cleaner 100 colliding with an obstacle, may be included in the second sensor according to the present disclosure.

In particular, the second sensor according to the present disclosure may obtain second data. The second sensor may obtain second data at preset cycles. Here, the “second data” refers to data related to the movement of the robotic vacuum cleaner 100 obtained through at least one second sensor, and may include at least one sensing value obtained through at least one second sensor. Here, the data related to the movement of the robotic vacuum cleaner 100 may refer to data on changes in sensing values resulting from the movement of the robotic vacuum cleaner 100 when moving through an area with a height difference from the floor surface, such as a carpeted area.

For example, the second data may include at least part of the sensing values of the acceleration sensor, angular velocity sensing values, and wheel sensor sensing values, as exemplified above. Additionally, any data related to the movement of the robotic vacuum cleaner 100 may be included in the second data according to the present disclosure.

At least one instruction related to the robotic vacuum cleaner 100 may be stored in the memory 130. Furthermore, the memory 130 may store an operating system (O/S) for operating the robotic vacuum cleaner 100. Furthermore, the memory 130 may store various software programs or applications for operating the robotic vacuum cleaner 100 according to various embodiments of the present disclosure. The memory 130 may include a semiconductor memory such as a flash memory, or a magnetic storage medium such as a hard disk, or the like.

Specifically, various software modules for operating the robotic vacuum cleaner 100 according to various embodiments of the present disclosure may be stored in the memory 130, and the processor 140 may execute various software modules stored in the memory 130 to control the operation of the robotic vacuum cleaner 100. That is, the memory 130 is accessed by the processor 140, and readout/recording/correction/deletion/update, and the like, of data in the memory 110 may be performed by the processor 140.

Meanwhile, the term “memory 130” in the present disclosure may be used to include the memory 130, a ROM or RAM within the processor 140, or a memory card (e.g., a micro SD card or memory stick) mounted on the robotic vacuum cleaner 100.

In particular, in one or more embodiments, the memory 130 may store information on the neural network model 1000, a training data set of the neural network model 1000, information on the traveling path of the robotic vacuum cleaner 100, type information on the type of the floor surface, etc. The information on the traveling path stored in the memory 130 may be updated based on user input, type information on the type of the floor surface, etc. In addition, various pieces of information necessary within the scope for achieving the object of the present disclosure may be stored in the memory 130, and the information stored in the memory 130 may be updated as received from an external device or input by a user.

The processor 140 controls the overall operation of the robotic vacuum cleaner 100. Specifically, the processor 140 is connected to a configuration of the robotic vacuum cleaner 100 including the first sensor, at least one second sensor, and the memory 130, and may control the overall operation of the robotic vacuum cleaner 100 by executing at least one instruction stored in the memory 130 as described above.

The processor 140 may be implemented in various schemes. For example, the processor 140 may be implemented as at least one of an application specific integrated circuit (ASIC), an embedded processor, a microprocessor, a hardware control logic, a hardware finite state machine (FSM), and a digital signal processor (DSP). Meanwhile, in the present disclosure, the term processor 140 may be used as meaning including a central processing unit (CPU), a graphic processing unit (GPU), a main processor unit (MPU), and the like.

In particular, in one or more embodiments, the processor 140 may accurately identify the type of the floor surface and perform operations appropriate to the identified type of the floor surface. Specifically, the processor 140 may perform processes related to various embodiments of the present disclosure using the plurality of modules. As illustrated in FIG. 3, the plurality of modules may include a preprocessing module 141, a postprocessing module 142, a control module 143, and a training module 144.

The plurality of modules may be implemented as hardware modules or software modules, and at least some of the modules may include the neural network model 1000. Hereinafter, for convenience of description, the following description will assume that all of the plurality of modules are implemented through the memory 130 and processor 140 of the robotic vacuum cleaner 100, but according to an embodiment, at least some of the plurality of modules may be implemented by an external device or a server.

While the robotic vacuum cleaner 100 moves along the traveling path, the processor 140 may obtain the first data related to the characteristics of the floor surface along the traveling path through the first sensor, and the second data related to the movement of the robotic vacuum cleaner 100 through at least one second sensor. Since the processes for obtaining the first and second data through the first and second sensors have been described above, a detailed description thereof will be omitted.

The processor 140 may input a traveling data set including at least part of the first and second data into the trained neural network model 1000, thereby obtaining the type information indicating the type of the floor surface. Specifically, the processor 140 may obtain the type information using the preprocessing module 141, the neural network model 1000, and the postprocessing module 142.

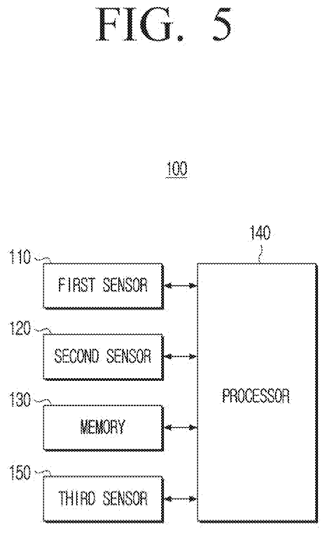

The “preprocessing module 141” refers to a module capable of obtaining a traveling data set based on the data obtained through the first sensor, the second sensor, and a third sensor (the third sensor will be described later in the description of FIGS. 5 to 7).

Here, the “traveling data set” refers to a set of data processed by the preprocessing module 141 and then input to the neural network model 1000, and may include at least part of the data obtained through the sensors.

The two are distinct in that the training data as described below is used for training the neural network model 1000, whereas the traveling data set includes data obtained in real time through the first, second, and third sensors while the robotic vacuum cleaner 100 is traveling. However, the types of data or sensed values included in the traveling data set are identical to those of the training data.

As illustrated in FIG. 3, when the first data is received from the first sensor and the second data is received from the second sensor, the preprocessing module 141 may process (or refine) at least part of the entire data, including the first and second data, thereby obtaining the traveling data set.

For example, the preprocessing module 141 may combine sensing values obtained through the first and second sensors over a certain period (e.g., 100 ms when the data collection cycle is 20 ms), determine which sensing values obtained through the first and second sensors will be included in the traveling data set, and may also weight the sensing values to obtain the traveling data set. Furthermore, the preprocessing module may encode or embed data according to the purpose of the neural network model 1000.

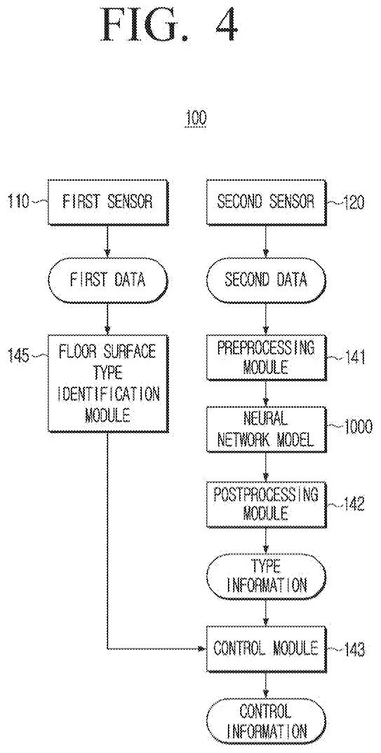

As such, the traveling data set may be obtained to include both at least part of the first data and at least part of the second data, or alternatively to include at least part of only one of the first data and the second data, depending on the determination of the preprocessing module 141. For example, in one or more embodiments, the traveling data set may include at least part of the first data without including any part of the second data, and in one or more other embodiments, the traveling data set may include at least part of the second data without including any part of the first data, as described later with reference to FIG. 4.

In the present disclosure, the “neural network model 1000” refers to an artificial intelligence model that includes a neural network trained to obtain the information indicating the type of the floor surface based on the traveling data set. As illustrated in FIG. 3, when the traveling data set is received from the preprocessing module 141, the neural network model 1000 may identify the type of the floor surface corresponding to the traveling data set and output a probability value indicating the type of floor surface to which the traveling data set corresponds.

For example, the neural network 1000 may be implemented as a convolutional neural network (CNN), a deep neural network (DNN), a recurrent neural network (RNN), a restricted Boltzmann machine (RBM), a deep belief network (DBN), a bidirectional recurrent deep neural network (BRDNN), etc., but is not limited to the above examples.

The “training data set” refers to a set of data used for training the neural network model 1000. Like the traveling data set, the training data set may include at least part of the data obtained through the first, second, and third sensors. Specifically, the training data set may include a carpet entry data set and a threshold traveling data set.

The carpet entry data set may include data for various cases in which the robotic vacuum cleaner 100 enters a carpet, based on how the robotic vacuum cleaner 100 ascends onto the carpet, such as straight movement, right-edge entry, left-edge entry, right-diagonal entry, and left-diagonal entry. The threshold traveling data set may include data for various single-height thresholds, such as 3 mm, 5 mm, and 7 mm, as well as composite height thresholds, such as multiple heights, to enable the neural network model 1000 to classify thresholds as floor surfaces without carpet. Furthermore, the training data set may include data for various carpet materials, such as short pile, long pile, mats, and tatami.

The neural network model 1000 may output various types of probability values depending on the type of training data set used for training and the predefined class (domain or category). For example, the neural network model 1000 may output a probability value for whether the carpet is present on a floor surface, a probability value for the material of the floor surface, or a probability value for the material of the carpet present on the floor surface. Meanwhile, the neural network model 1000 may be implemented as multiple models trained to output the output values for each of the various types described above.

In particular, since the neural network model 1000 is trained based on training data that includes not only the first data on floor surface features obtained using ultrasonic waves but also data related to the movement of the robotic vacuum cleaner 100, the model may be trained to obtain the output values for the type of the floor surface by reflecting the information on the movement of the robotic vacuum cleaner 100 when the robotic vacuum cleaner 100 ascends onto or descends from the carpet.

Meanwhile, the description of the present disclosure will assume that the neural network model 1000 is implemented on-device in the robotic vacuum cleaner 100. However, the neural network model 1000 may be included in an external server, and the robotic vacuum cleaner 100 may obtain the output value of the neural network model 1000 by receiving the output value through communication with the external server.

The “post-processing module 142” refers to a module capable of obtaining the type information based on the output of the neural network model 1000. As illustrated in FIG. 3, when the information on the probability values is received from the neural network model 1000, the postprocessing module 142 may output the type information indicating the type of the floor surface corresponding to the traveling data set based on the probability value indicating the type of the floor surface corresponding to the traveling data set.

The “type information” is used as a general term for information indicating the type of the floor surface along the traveling path of the robotic vacuum cleaner 100. Specifically, the type information may include information regarding at least one of whether a carpet is present on the floor surface along the traveling path, the material of the floor surface, or the material of the carpet.

For example, when the probability value for the probability of the carpet being present on the floor surface is greater than or equal to the probability value for the probability of no carpet being present on the floor surface, the postprocessing module 142 may obtain the type information indicating the presence of the carpet on the floor surface. Meanwhile, when the neural network model 1000 is implemented as multiple neural network models 1000 as described above, the postprocessing module 142 may combine the probability values output by each of the multiple neural network models 1000 using a voting technique or the like, and obtain type information corresponding to the class most frequently selected by the multiple neural network models 1000.

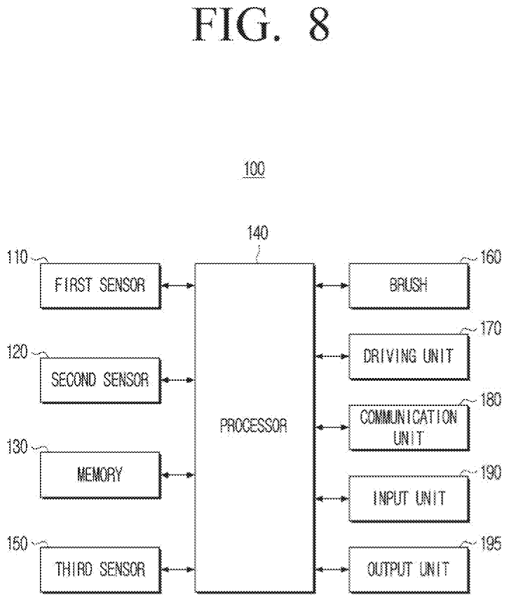

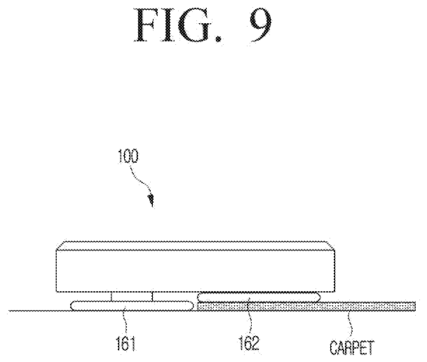

Various examples of the type information and various embodiments related to the control of the robotic vacuum cleaner 100 operation will be described in more detail with reference to FIGS. 8 and 9.

Meanwhile, for the sake of detailed description, the above description assumes that the preprocessing module 141, the neural network model 1000, and the postprocessing module 142 are implemented as separate modules and models. However, at least some of the preprocessing module 141, the neural network model 1000, and the postprocessing module 142 may be implemented as a single neural network model 1000. For example, the neural network model 1000 may not output the probability value for the type of the floor surface, but may also perform postprocessing on the probability value to output the type information.

In addition, although the embodiments described above mainly explain a case in which the type information is obtained through the neural network model 1000, the present disclosure is not limited thereto. As described later with reference to FIG. 4, the type information indicating the type of the floor surface, including information on whether a carpet is present on the floor surface, may also be obtained based on at least part of the traveling data set without using an output of the neural network model 1000. For example, when the first data included in the traveling data set indicates that a carpet is present on the floor surface, the type information indicating that the carpet is present on the floor surface may be obtained based on the first data alone. Accordingly, in the present disclosure, an expression that the type information is obtained based on the traveling data set is used to encompass both a case in which the type information is obtained using the neural network model 1000 and a case in which the type information is obtained without using the neural network model 1000.

The “training module 144” refers to a module capable of training the neural network model 1000. Specifically, the training module 144 may train the neural network model 1000 using the supervised learning based on the training data set including labels. Additionally, the neural network model 1000 may be trained using unsupervised learning, semi-supervised learning, or reinforcement learning.

Meanwhile, the training module 144 may update the training data set using a combination of the traveling data set and type information obtained while the robotic vacuum cleaner 100 is traveling along the traveling path, and retrain the neural network model 1000 based on the updated training data set.

When the type information is obtained, the processor 140 may control the operation of the robotic vacuum cleaner 100 based on the type information. Specifically, the processor 140 may control the operation of the robotic vacuum cleaner 100 using the control module 143.

As described above, the type information used by the processor 140 to control the operation of the robotic vacuum cleaner 100 is obtained based on the traveling data set. Accordingly, in the present disclosure, an expression that the processor 140 controls the operation of the robotic vacuum cleaner 100 based on the type information may be understood as the processor 140 controlling the operation of the robotic vacuum cleaner 100 based on the traveling data set from which the type information is obtained, and these two expressions are used to refer to the same control operation unless the context clearly indicates otherwise. Similarly, an expression that the traveling data set indicates a certain type of the floor surface, such as the presence of a carpet on the floor surface, may be understood as the type information obtained based on the traveling data set indicating the type of the floor surface.

The “control module 143” refers to a module that may control the operation of the robotic vacuum cleaner 100 based on the type information. As illustrated in FIG. 3, when the type information is received from the postprocessing module 142, the control module 143 obtains a control signal for controlling the operation of the robotic vacuum cleaner 100 based on the type information, and may control the operation of the robotic vacuum cleaner 100 based on the obtained control signal.

For example, when the type information identifies the carpet on the floor surface, the processor 140 may control the wet brush to be lifted while cleaning the carpeted area, and may also control the robotic vacuum cleaner 100 to bypass the carpeted area by changing the traveling path.

Various embodiments related to the control of the operation of the robotic vacuum cleaner 100 based on the type information are described in more detail with reference to FIGS. 8 and 9.

According to one or more embodiments described above with reference to FIGS. 2 and 3, the robotic vacuum cleaner 100 trains the neural network model 1000 using not only data on the characteristics of the floor surface obtained using ultrasonic waves but also data related to the movement of the robotic vacuum cleaner 100, efficiently and accurately identifies the type of the floor surface using the trained neural network model 1000, and performs an operation suited to the identified type of floor surface.

In particular, the robotic vacuum cleaner 100 may classify carpet entry cases and carpet materials with high accuracy, which could not be accurately classified using only ultrasonic sensors. In addition, since the sensors basically used for autonomous driving of the robotic vacuum cleaner 100 are also used to identify the type of the floor surface, the type of the floor surface may be accurately identified with high efficiency and low cost.

For example, even when there is a carpet in the right area of the traveling path and no carpet in the left area of the traveling path as illustrated in FIG. 1, the robotic vacuum cleaner 100 according to the present disclosure may identify the carpeted area with high accuracy because it identifies the type of the floor surface not only by relying on the ultrasonic sensor but also by using data related to the movement of the robotic vacuum cleaner 100.

FIG. 4 is a diagram for describing one or more embodiments related to a floor surface type identification module 145 according to the present disclosure.

The embodiments of FIGS. 2 and 3 illustrate the case where the first and second data are input to the neural network model 1000. However, as illustrated in FIG. 4, the processor 140 may also obtain type information by inputting only at least part of the second data among the first and second data to the neural network model 1000.

That is, in the embodiment of FIG. 4, the first data is input to the floor surface type identification module 145 without being input to the neural network model 1000, and only the second data may be input to the neural network model 1000.

The “floor surface type identification module 145” refers to a module capable of identifying the type of the floor surface based on the first data obtained through the first sensor. As illustrated in FIG. 4, when the first data is received from the first sensor, the floor surface type identification module 145 may obtain a floor surface type identification result using only the first data, without using the second data and the output of the neural network model 1000.

As described above, the first data may be composed of binary values, including a value of 1, indicating the presence of carpet in the sensing target area, and a value of 0, indicating the absence of carpet in the sensing target area. The floor surface type identification module 145 may identify the presence of carpet in the sensing target area when the value in the first data is 1, and identify the absence of carpet in the sensing target area when the value in the first data is 0.

When the presence of the carpet on the floor surface is identified based on the first data, the processor 140 may control the operation of the robotic vacuum cleaner 100 based on the identification result indicating the presence of carpet on the floor surface. In other words, when a carpet is identified on the floor surface based on the first data, this means that the presence of the carpet on the floor surface has been confirmed without using the neural network model 1000. Therefore, the processor 140 may control the operation of the robotic vacuum cleaner 100 based on the identification result of the presence of the carpet on the floor surface without using the output of the neural network model 1000.

When a carpet is identified as not being present on the floor surface based on the first data, the processor 140 may control the operation of the robotic vacuum cleaner 100 based on the type information. In other words, when a carpet is identified as not being present on the floor surface based on the first data, this means that there is still a possibility of identifying the carpet on the floor surface when the neural network model 1000 is also used. Therefore, the processor 140 may identify the type of the floor surface based on the type information obtained using the neural network model 1000 and control the operation of the robotic vacuum cleaner 100.

Here, since the type information used for controlling the operation of the robotic vacuum cleaner 100 in the case where the carpet is identified as not being present on the floor surface based on the first data is obtained by inputting at least part of the second data among the first data and the second data to the neural network model 1000 as described above with reference to FIG. 4, the control of the operation of the robotic vacuum cleaner 100 in this case may also be expressed as the control corresponding to the second data. That is, in this case, an expression that the operation of the robotic vacuum cleaner 100 is controlled corresponding to the second data and an expression that the operation of the robotic vacuum cleaner 100 is controlled based on the type information obtained from the second data are used to refer to the same control operation in the present disclosure.

Meanwhile, in FIG. 4, the floor surface type identification module 145 uses the first data and the neural network model 1000 uses the second data. However, according to the embodiment, the process of the neural network model 1000 using the second data may be omitted. That is, the processor 140 identifies the type of the floor surface based on the first data before obtaining the type information using the neural network model 1000, and when it is determined that the carpet is present on the floor surface based on the first data, the processor 140 may not perform the process of obtaining the type information based on the second data.

By identifying the type of the floor surface based on the first data before obtaining the type information using the neural network model 1000, the overall amount of computation may be reduced, allowing the type of the floor surface to be identified in a more efficient manner. Meanwhile, when the type of the floor surface is identified based on the first data after obtaining the type information using the neural network model 1000, the operation process of the neural network model 1000 is always performed regardless of the identification result based on the first data, so there is an advantage in that the process of identifying the type of the floor surface based on the first data may be easily added without significantly changing the algorithm according to the configuration of FIG. 3.

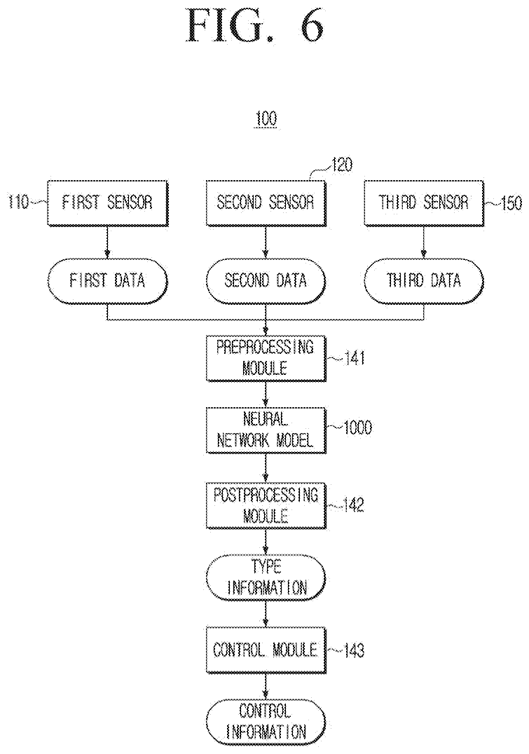

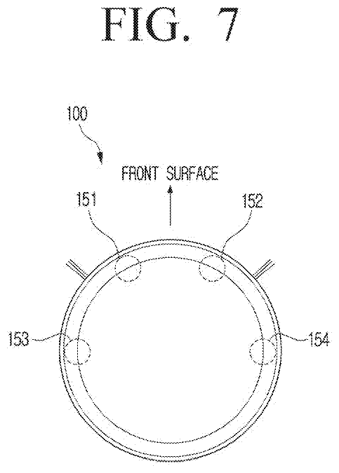

FIG. 5 is a block diagram illustrating the configuration of a robotic vacuum cleaner 100 according to one or more embodiments of the present disclosure, FIG. 6 is a diagram for describing one or more embodiments related to a third sensor according to the present disclosure, and FIG. 7 is a diagram for describing one or more embodiments related to the location and number of third sensors. This will be described below with reference to FIGS. 5 and 7 together.

As illustrated in FIG. 5, the robotic vacuum cleaner 100 may further include a third sensor in addition to the first sensor, the second sensor, the memory 130, and the processor 140.

The “third sensor” is a sensor that utilizes infrared light and may also be referred to as an “infrared sensor.” Specifically, the third sensor emits infrared light and receives infrared light reflected from the floor surface. Since the degree of infrared light reflection may vary depending on the color of the floor surface, the third sensor may obtain information on the reflectivity of the floor surface based on the intensity of the received infrared light.

In the description of the present disclosure, data obtained through the third sensor is referred to as “third data.” The third data includes information on the reflectivity of the floor surface and may be related to the color of the floor surface. Specifically, since the reflectivity of infrared light may vary depending on the color of the floor surface, the information on the reflectivity of the floor surface may indicate the color of the floor surface. For example, the third data may represent the information on the difference in reflectivity between a carpeted area and a non-carpeted area on the floor surface, and may also represent the information on the difference in reflectivity depending on the carpet material.

That is, the infrared sensor mounted on the robotic vacuum cleaner 100 is generally used to obtain the information on the distance between the robotic vacuum cleaner 100 and the floor surface and to determine whether the robotic vacuum cleaner 100 has fallen. In the present disclosure, it may be used to acquire information about the reflectivity of the floor surface and to obtain third data related to the color of the floor surface.

The third sensor may be at least one, i.e., one or more. As illustrated in FIG. 7, the at least one third sensor may include a third sensor 151 disposed on the front left side of the robotic vacuum cleaner 100, a third sensor 152 disposed on the front right side, a third sensor 153 disposed on the left side, and a fourth sensor 154 disposed on the right side. FIG. 7 illustrates the location of the third sensor based on a top-down view of the robotic vacuum cleaner 100. At least one third sensor may actually be disposed on the floor surface of the robotic vacuum cleaner 100.

When the third data related to the color of the floor surface is obtained through at least one third sensor, the processor 140 inputs the traveling data set including at least part of the first data, second data, and third data to the trained neural network model 1000, thereby obtaining the type information. That is, the processor 140 may train the neural network model 1000 based on the training data set that includes not only the first and second data, but also the third data. Accordingly, the neural network model 1000 may obtain the type information by reflecting not only the first and second data, but also the third data related to the color of the floor surface.

More specifically, as illustrated in FIG. 6, the processor 140 inputs the first data, the second data, and the third data to the preprocessing module 141, and obtains the type information through the preprocessing module 141, the neural network model 1000, and the postprocessing module 142. However, since the preprocessing module 141, the neural network model 1000, and the postprocessing module 142 have been described above, a detailed description of the same content will be omitted.

Meanwhile, the third data obtained through the third sensor using infrared rays may result in false detection when the color of the floor surface or carpet changes significantly. Therefore, the processor 140 may include the third data in the traveling data set without directly inputting the third data to the neural network model 1000, and after preprocessing the third data, it may input the third data to the neural network model 1000. Here, the traveling data set may include data related to the shaking of the robotic vacuum cleaner 100 among the second data and third data. Here, “data related to shaking” may include pitch and roll values of the gyro sensor among the angular velocity sensors.

For example, when there is little change in the data related to the shaking of the robotic vacuum cleaner 100 among the second data, but a significant change in the third data related to the color change of the floor surface, this does not indicate the presence of the carpeted area with a height difference from the floor surface, but rather the presence of an area where the color of the floor surface drastically changes.

On the other hand, when there is a significant change in the data related to the shaking of the robotic vacuum cleaner 100 among the second data, and also a significant change in the third data related to the color change of the floor surface, this does not indicate the presence of an area where the color of the floor surface drastically changes, but rather the presence of a carpeted area with a height difference from the floor surface.

Accordingly, the processor 140 may eliminate the possibility of false detection of the floor surface type due to color change by not including third data indicating the presence of an area where the color of the floor surface has drastically changed in the traveling data set.

In one or more embodiments, when the value representing the amount of change in data related to the shaking of the robotic vacuum cleaner 100 is greater than or equal to a first threshold value and the value representing the amount of change in the third data is greater than or equal to a second threshold value, the processor 140 may include the third data in the traveling data set. On the other hand, even when the value representing the amount of change in the third data is greater than or equal to the second threshold value, when the value representing the amount of change in the data related to the shaking of the robotic vacuum cleaner 100 is less than the first threshold value, the processor 140 may not include the third data in the traveling data set.

Meanwhile, in one or more embodiments, the processor 140 may use a mathematical expression, such as the following Mathematical Expression 1, to transform part of the traveling data set so that a value representing the amount of change in data related to the shaking of the robotic vacuum cleaner 100 and a value representing the amount of change in third data have larger values, and input the transformed traveling data set to the neural network model 1000 to obtain the type information.

$$\{ std ( gyro\_pitch ) + std ( gyro\_roll ) \} * \{ std ( IR 1 ) + std ( IR 2 ) + std ( IR 3 ) + std ( IR 4 ) \} \qquad [ Mathematical Expression 1 ]$$

In Mathematical Expression 1, std refers to the standard deviation, gyro_pitch and gyro_roll refer to the pitch value and roll value of the gyro sensor among the angular velocity sensors, and IR1, IR2, IR3, and IR4 refer to sensing values obtained through each of the four third sensors.

The calculated value of Mathematical Expression 1 may have a relatively higher value (e.g., 300 to 3000) when the robotic vacuum cleaner 100 climbs or descends the carpet, and may have a relatively lower value (e.g., less than 300) when the robotic vacuum cleaner 100 does not pass over the carpet and there is simply a change in the color of the floor surface. In addition to Mathematical Expression 1, various mathematical expressions may be applied in the present disclosure to transform part of the traveling data set so that the resulting value increases as the amount of change in data related to the shaking of the robotic vacuum cleaner 100 and the amount of change in the third data increase.

Meanwhile, the above has described an embodiment in which the processor 140 inputs at least part of the third data itself obtained through the third sensor into the trained neural network model 1000. However, the processor 140 may also obtain information on the color of the floor surface based on information on the reflectivity of the floor surface included in the third data, and input information on the color of the floor surface into the trained neural network model 1000.

According to one or more of the embodiments described above with reference to FIGS. 5 to 7, the robotic vacuum cleaner 100 trains the neural network model 1000 using not only data on floor surface characteristics obtained using ultrasound and data related to the movement of the robotic vacuum cleaner 100, but also data related to the color of the floor surface obtained using infrared rays. The trained neural network model 1000 may accurately identify the type of the floor surface.

In particular, according to the related art, as illustrated in FIG. 1, when a carpet is present on the right side of the traveling path and no carpet is present on the left side of the traveling path, the right side of the robotic vacuum cleaner 100, which does not have an ultrasonic sensor, may step onto and then descend the carpet, potentially leading the robotic vacuum cleaner 100 to identify itself as climbing up and down a threshold. On the other hand, by utilizing the data related to the color of the floor surface obtained using infrared according to the present disclosure, even in cases such as those illustrated in FIG. 1, the robotic vacuum cleaner 100 may be identified as having the carpeted area on the floor surface, rather than being identified the robotic vacuum cleaner 100 as climbing up and down the threshold value.

Furthermore, the robotic vacuum cleaner 100 may prevent misrecognition of areas with abrupt color changes on the floor surface as carpeted areas by preprocessing the third data using data related to the shaking of the robotic vacuum cleaner 100 among the second data.

FIG. 8 is a block diagram illustrating the configuration of the robotic vacuum cleaner 100 according to one or more embodiments of the present disclosure, and FIG. 9 is a diagram illustrating a control process of a wet brush according to one or more embodiments. This will be described below with reference to FIGS. 8 and 9 together.

As illustrated in FIG. 8, the robotic vacuum cleaner 100 may further include the first sensor, the second sensor, the memory 130, the processor 140, and the third sensor, as well as a brush 160, a driving unit 170, a communication unit 180, an input unit 190, and an output unit 195. The configurations illustrated in FIGS. 2, 5, and 8 are merely exemplary, and in implementing the present disclosure, new configurations may be added to, or some configurations may be omitted from, those shown in FIGS. 2, 5, and 8.

The brush 160 may sweep away contaminants placed on the floor surface so that the suction unit of the robotic vacuum cleaner 100 may easily capture the contaminants. Specifically, the brush may include a dry brush and a wet brush.

The “dry brush” refers to a brush capable of cleaning a floor surface without wetting it with water. Specifically, the dry brush may sweep away contaminants such as dust disposed on the floor surface, allowing the suction unit of the robotic vacuum cleaner 100 to easily capture the contaminants. The operating mode for performing cleaning using the dry brush may be referred to as a “dry mode.”

The “wet brush” refers to a brush capable of cleaning a floor surface with water in a wet state, and may be referred to by terms such as a “wet mop.” For example, the wet brush may receive water from a user or a water tank, detach contaminants adsorbed on the floor surface in a wet state, and sweep away the detached contaminants, allowing the suction unit of the robotic vacuum cleaner 100 to easily capture the detached contaminants. The operating mode for performing cleaning using the wet brush may be referred to as a “wet mode.”

When the robotic vacuum cleaner 100 includes both the dry brush and the wet brush and is implemented so that the position of the wet brush may be controlled, the robotic vacuum cleaner 100 may perform cleaning without using the wet brush when operating in the dry mode, and may perform wet cleaning using the wet brush by automatically controlling the position of the wet brush when operating in wet mode.

The driving unit 170 includes at least one motor and may control the driving of the robotic vacuum cleaner 100. Specifically, the driving unit 170 may include a suction motor, a wet brush control motor, a wheel control motor, and the like. At least one motor included in the driving unit 170 may be implemented as various types of motors, such as a direct current electric motor (DC motor), an alternating current electric motor (AC motor), or a brushless DC electric motor (BLDC motor).

The term “suction motor” refers to a motor capable of generating suction pressure. Specifically, when a control signal is received from the processor 140 and power is supplied from the power supply, the impeller may rotate by driving the suction motor. The rotation of the impeller generates suction pressure, which may draw air containing contaminants into the suction port of the robotic vacuum cleaner 100. Meanwhile, as the speed of the suction motor increases, the suction pressure may increase.

The term “wet brush control motor” refers to a motor capable of controlling the position of the wet brush. Specifically, the processor 140 may control the position of the wet brush by controlling the wet brush control motor connected to the wet brush.

For example, the processor 140 may control the wet brush motor to lower the position of the wet brush to clean the floor surface using the wet brush, thereby allowing the wet brush to contact the floor surface. Additionally, the processor 140 may control the wet brush motor to raise the position of the wet brush so that the wet brush does not come into contact with the floor surface, thereby preventing the wet brush from cleaning the floor surface.

The ‘wheel control motor’ may control the operation of the wheels included in the robotic vacuum cleaner 100. Specifically, the wheel control motor may control the rotational direction and speed of the wheels included in the robotic vacuum cleaner 100, thereby controlling the movement direction and speed of the robotic vacuum cleaner 100. When the robotic vacuum cleaner 100 includes two wheels, a left wheel and a right wheel, the wheel control motor may include a left wheel control motor and a right wheel control motor, and the left wheel control motor and the right wheel control motor may control the rotational direction and speed of the left wheel and the right wheel, respectively.

As described above, the processor 140 may control the operation of the robotic vacuum cleaner 100 based on the type information. Below, various embodiments in which the processor 140 controls the dry brush, the wet brush, and driving unit 170 based on type information are described.

In one or more embodiments, when a carpet is identified based on type information while cleaning the floor surface using the wet brush, the processor 140 may control the drive unit 170 (specifically, the wet brush control motor) to raise the wet brush while cleaning the carpeted area. Meanwhile, the processor 140 may control the drive unit 170 to lower the wet brush when the robotic vacuum cleaner 100 leaves the carpeted area.

In other words, the processor 140 may control the robotic vacuum cleaner 100 to raise the wet brush before entering the carpeted area while operating in the wet mode to prevent the carpet from getting wet, and to lower the mop again upon leaving the carpeted area to clean the floor surface.

In one or more embodiments, while the robotic vacuum cleaner 100 is performing cleaning on the floor surface using the dry brush and the carpet is identified on the floor surface based on the type information, the processor 140 may control the driving unit 170 (specifically, the suction motor) to increase the suction force of the robotic vacuum cleaner 100 while performing cleaning on the carpeted area.

In other words, the processor 140 may control the robotic vacuum cleaner 100 to increase the suction force when the robotic vacuum cleaner 100 enters a carpeted area while traveling in the dry mode to enhance the carpet cleaning effect, and to decrease the suction force again when the robotic vacuum cleaner 100 leaves the carpeted area.

In one or more embodiments, the processor 140 may modify information on a traveling path stored in the memory 130 based on the type information, and control the driving unit 170 (specifically, the wheel control motor) to drive the robotic vacuum cleaner 100 based on the modified traveling path information.

Specifically, the type information obtained using the neural network model 1000 may include information on whether the robotic vacuum cleaner 100 is entering or exiting the carpeted area, as well as the direction of entry or exit. Furthermore, the processor 140 may modify the traveling path based on the identified carpet entry and exit directions according to the type information, such that the cleaning operation at the boundary of the carpeted area is effectively and accurately changed.

For example, when one wheel of the robotic vacuum cleaner 100 is predicted to touch the edge of the carpeted area along the traveling path, the processor 140 may modify the traveling path so that the robotic vacuum cleaner 100 moves only over the floor surface or travels only over the carpeted area. As another example, when the robotic vacuum cleaner 100 is predicted to enter or exit the carpeted area obliquely along the traveling path, the processor 140 may modify the traveling path so that the robotic vacuum cleaner 100 enters or exits the carpeted area in the non-oblique direction. As another example, when the automatic raising and lowering of the wet brush is not implemented, the processor 140 may modify the traveling path so that the robotic vacuum cleaner 100 bypasses the carpeted area.

Meanwhile, the type information obtained using the neural network model 1000 may include information on the material of the carpet, and the processor 140 may control the driving unit 170 based on the information on the material of the carpet. More specifically, the type information obtained using the neural network model 1000 may include information on whether the carpet is made of long hair greater than a critical length or short hair less than a critical length, and the processor 140 may control the driving unit 170 based on information on the length of carpet hair based on the type information.

In one or more embodiments, when a carpet of a first material is identified as being present on the floor surface based on type information while cleaning the floor surface using a wet brush, the processor 140 may control the driving unit to raise the wet brush while cleaning the carpeted area where the carpet is present. Here, the term “first material” is used as a general term for the material of the carpet that enables efficient cleaning when the wet brush is raised, and may be particularly related to the length of the carpet hairs, as described below.

Specifically, when a length of carpet hair present on the floor surface is identified as being less than a threshold length based on type information while cleaning the floor surface using the wet brush, the processor 140 may control the driving unit 170 to raise the wet brush while cleaning the carpeted area where the carpet is present.

In other words, when a carpet is determined to have short hair, the processor 140 may control the drive unit 170 to raise the wet brush while cleaning the carpeted area where carpet is present, since lifting the wet brush may not touch the carpet.

In one or more embodiments, while performing cleaning of the floor surface using a wet brush, if it is identified, based on type information, that a carpet of a second material different from the first material is present on the floor surface, the information on the traveling path stored in the memory may be modified, and the drive unit may be controlled to allow the robotic vacuum cleaner to travel based on the information on the modified traveling path. Here, the term “second material” is used as a general term to refer to the material of the carpet that is difficult to clean efficiently even when raising the wet brush, and may be particularly related to the length of the carpet hair, as described below.

Specifically, during cleaning of the floor surface using a wet brush, if it is identified, based on type information, that the length of carpet hair present on the floor surface is equal to or greater than a threshold length, the processor 140 modifies the traveling path information stored in the memory 130 and controls the driving unit 170 to drive the robotic vacuum cleaner 100 based on the modified traveling path information.

In other words, when the length of carpet hair is identified as long, the carpet may still be touched even when the wet brush is raised. Therefore, the processor 140 may modify the traveling path to include a location for detaching the wet brush or to bypass the carpeted area.

Meanwhile, the type information obtained using the neural network model 1000 may include information indicating the type of the floor surface corresponding to each of the first and second side surfaces of the traveling path. The wet brush may include a first wet brush disposed on the first side surface of the robotic vacuum cleaner 100 and a second wet brush disposed on a side different from the first side surface. Here, the first side surface refers to one side of the robotic vacuum cleaner 100, and the second side surface refers to another side of the robotic vacuum cleaner 100 that is different from the first side surface.

Referring to the example of FIG. 9, the first side surface may be one of the left and right sides of the robotic vacuum cleaner 100, and the second side surface may be another side of the left and right sides of the robotic vacuum cleaner 100 that is different from the first side surface. However, in the present disclosure, there are no particular limitations on the positions of the first side surface and the second side surface, and there are no particular limitations on the relationship between the positions of the first side surface and the second side surface.

In one or more embodiments, when a composite area is identified based on type information, where a carpet is present on the floor surface corresponding to the first side surface and a carpet is not present on the floor surface corresponding to the second side surface, the processor 140 may control the driving unit 170 to raise the first wet brush 161 and not to raise the second wet brush 162 while cleaning the composite area using the wet brush.

Referring to the example of FIG. 9, when the floor surface types of the left and right areas of the traveling path of the robotic vacuum cleaner 100 are different, the processor 140 may control the driving unit to raise one of the wet brushes located on the left side and the wet brushes located on the right side while cleaning the floor surface, thereby effectively performing the cleaning operation suited to the floor surface types of the left and right areas, respectively.

Meanwhile, the type information obtained using the neural network model 1000 may include information indicating the material of the floor surface. Furthermore, the processor 140 may identify the material of the floor surface based on the type information and control the driving unit 170 based on the identified material. For example, when the material of the floor surface is identified as wood, the processor 140 may minimize water damage to the wood floor surface by reducing the amount of water supplied to the wet brush compared to cases where the material of the floor surface is vinyl, marble, or tile.

Meanwhile, the processor 140 may distinguish multiple areas of the floor surface based on the identified material of the floor surface. For example, the processor 140 may distinguish a first area where carpet is present and a second area where carpet is not present by identifying the boundary where the material of the identified floor surface changes. Accordingly, even in cases where the accuracy of floor surface classification may be reduced, such as when obstacles are disposed at cycles similar to the width of a door, the processor may accurately distinguish multiple areas of the floor surface, enabling appropriate cleaning to be performed for each area.

Meanwhile, the processor 140 may store information on a location identified as a carpeted area in the memory 130. Specifically, the processor 140 may update the traveling path information stored in the memory 130 by modifying the traveling path based on the location identified as a carpeted area.

The communication unit 180 includes a circuit and may communicate with an external device. Specifically, the processor 140 may receive various data or information from an external device connected via the communication unit 180 and may also transmit various data or information to the external device.

The communication interface 180 may include at least one of a WiFi module, a Bluetooth module, a wireless communication module, an NFC module, and an ultra-wide band (UWB) module. Specifically, the WiFi module and the Bluetooth module may communicate via WiFi or Bluetooth, respectively. In the case of using the Wi-Fi module or the Bluetooth module, various types of connection information such as an SSID may first be transmitted and received, and after establishing the communication connection by using the connection information, various types of information may be transmitted and received.

In addition, the wireless communication module may perform communications according to various communication standards, such as IEEE, Zigbee, 3rd generation (3G), 3rd generation partnership project (3GPP), long term evolution (LTE), and 5th generation (5G). The NFC chip may perform communications in a near field communication (NFC) manner using a band of 13.56 MHz among various RF-ID frequency bands such as 135kHz, 13.56 MHz, 433 MHz, 860 to 960 MHz, and 2.45GHz. In addition, the UWB module may accurately measure a time of arrival (ToA), which is the time it takes for a pulse to reach a target, and an angle of arrival (AoA), which is a pulse arrival angle at a transmitting device, through communication between UWB antennas, thereby enabling precise distance and location recognition within an error range of several tens of centimeters indoors.

In particular, in one or more embodiments, the processor 140 may receive the information on the neural network model 1000, the training data set of the neural network model 1000, the information on the traveling path of the robotic vacuum cleaner 100, etc., from the external device through the communication unit 180. The processor 140 may receive a signal corresponding to a user input for controlling the operation of the robotic vacuum cleaner 100 from the external device through the communication unit 180, and may receive a signal corresponding to a user input for modifying the traveling path from the external device through the communication unit 180. The processor 140 may control the communication unit 180 to transmit information on the updated traveling path to the external device. The processor 140 may control the communication unit 180 to transmit the information corresponding to the message for guiding the user to detach or attach the wet brush to or from the external device.

The input unit 190 includes a circuit, and the processor 140 may receive user commands for controlling the operation of the robotic vacuum cleaner 100 through the input unit 190. Specifically, the input unit 190 may be configured with components such as a microphone, a camera, and a remote control signal receiving unit. Furthermore, the input unit 190 may be implemented as a touch screen included in a display. In particular, the microphone may receive a voice signal and convert the received voice signal into an electrical signal.

In particular, in one or more embodiments, the processor 140 may receive user input, such as a user input for controlling the operation of the robotic vacuum cleaner 100, a user input for modifying a traveling path, and the like. The processor 140 may receive a user voice for controlling the operation of the robotic vacuum cleaner 100 through the microphone.

The output unit 195 includes a circuit, and the processor 140 may output various functions that the robotic vacuum cleaner 100 may perform through the output unit 195. In addition, the output unit 195 may include at least one of a display, a speaker, and an indicator.

The display may output video data under the control of the processor 140. Specifically, the display may output videos pre-stored in the memory 130 under the control of the processor 140. In particular, the display according to an embodiment of the present disclosure may display a user interface (UI) stored in the memory 130. The display may be implemented as a liquid crystal display panel (LCD), organic light emitting diodes (OLED), etc., and may also be implemented as a flexible display, a transparent display, etc., depending on the circumstances. However, the display according to the present disclosure is not limited to a specific type.

The speaker may output audio data under the control of the processor 140, and the indicator may be turned on under the control of the processor 140.

In particular, in one or more embodiments, the processor 140 may control the output unit 195 to provide a message to inform the user that the traveling path has been modified. The processor 140 may control the output unit 195 to provide a message indicating that the wet brush has automatically been raised or lowered. The processor 140 may control the output unit 195 to provide a message to inform the user to detach or attach the wet brush.

According to one or more embodiments described above with reference to FIGS. 8 and 9, the robotic vacuum cleaner 100 may perform an operation suited to the identified floor type. In particular, when the robotic vacuum cleaner 100 determines that a carpet is present on the floor surface, it may perform operations suited to the carpeted area in both dry and wet modes, respectively, when entering the carpeted area.

Meanwhile, FIGS. 2, 5, and 8 merely describe the main components of the robotic vacuum cleaner 100. The robotic vacuum cleaner 100 may further include components such as a suction port capable of sucking up contaminants, a camera capable of obtaining images of the cleaning space, a global positioning system (GPS) sensor capable of obtaining information on the location of the robotic vacuum cleaner 100, and a LiDAR sensor capable of obtaining information on the distance to obstacles.

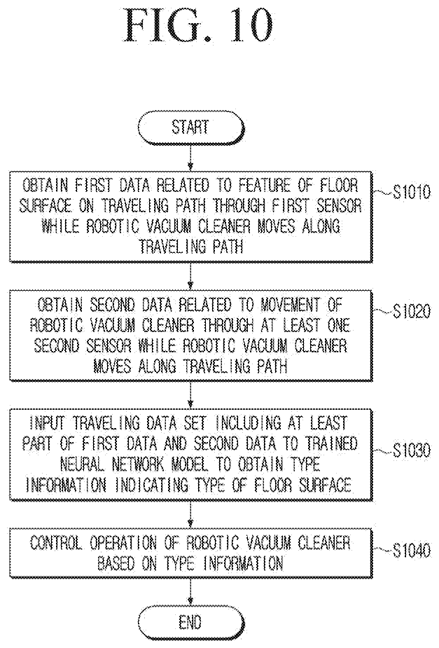

FIG. 10 is a flowchart illustrating a method for controlling a robotic vacuum cleaner 100 according to one or more embodiments of the present disclosure.

Referring to FIG. 10, the robotic vacuum cleaner 100 may obtain first data related to the characteristics of the floor surface along the traveling path through a first sensor while the robotic vacuum cleaner 100 moves along the traveling path (S1010). Here, the first sensor is a sensor that uses ultrasonic waves, and the first data refers to data related to the characteristics of the floor surface along the traveling path of the robotic vacuum cleaner 100 obtained through the first sensor.

In addition, the robotic vacuum cleaner 100 may obtain second data related to the movement of the robotic vacuum cleaner 100 through at least one second sensor while the robotic vacuum cleaner 100 moves along the traveling path (S1020). The second sensor refers to a sensor related to the movement of the robotic vacuum cleaner 100, and the second data refers to data related to the movement of the robotic vacuum cleaner 100 obtained through at least one second sensor.

Once the first and second data are obtained, the robotic vacuum cleaner 100 inputs a traveling data set including at least a portion of the first and second data into the trained neural network model 1000 to obtain the type information indicating the type of the floor surface (S1030). The neural network model 1000 refers to a model including a neural network trained to obtain information indicating the type of the floor surface based on the traveling data set. The type information may include information regarding at least one of whether a carpet is present on the floor surface along the traveling path, the material of the floor surface, or the material of the carpet.

Once the type information is obtained, the robotic vacuum cleaner 100 may control its operation based on the type information (S1040). Specifically, when the type information identifies the presence of a carpet on the floor surface, the robotic vacuum cleaner 100 may control the lifting of the wet brush while cleaning the carpeted area, and may also control the robotic vacuum cleaner 100 to bypass the carpeted area by changing the traveling path.

Meanwhile, the method for controlling a robotic vacuum cleaner 100 according to the above-described embodiment may be implemented as a program and provided to the robotic vacuum cleaner 100. In particular, the program including the method for controlling a robotic vacuum cleaner 100 may be provided by being stored in a non-transitory computer readable medium.

Specifically, in a non-transitory computer-readable recording medium including a program for executing a method for controlling a robotic vacuum cleaner 100, the method for controlling a robotic vacuum cleaner 100 includes a step of obtaining first data related to a feature of a floor surface on a traveling path through a first sensor using ultrasonic waves while the robotic vacuum cleaner 100 moves along a traveling path, a step of obtaining second data related to a movement of the robotic vacuum cleaner 100 through at least one second sensor related to a movement of the robotic vacuum cleaner 100 while the robotic vacuum cleaner 100 moves along the traveling path, a step of inputting a traveling data set including at least a portion of the first data and the second data to a trained neural network model 1000 to obtain type information indicating a type of floor surface, and a step of controlling an operation of the robotic vacuum cleaner 100 based on the type information.

In the above, the method for controlling a robotic vacuum cleaner 100, and a computer-readable recording medium including a program executing the method for controlling a robotic vacuum cleaner 100 have been briefly described. However, this is merely to omit redundant description, and various embodiments of the robotic vacuum cleaner 100 may also be applied to the method for controlling a robotic vacuum cleaner 100 and the computer-readable recording medium including a program executing the method for controlling a robotic vacuum cleaner 100.

The artificial intelligence-related functions according to the present disclosure are operated through the processor 140 and the memory 130 of the robotic vacuum cleaner 100. The processor 140 may include one or more processors 140. In this case, the one or more processors 140 may include at least one of a central processing unit (CPU), a graphic processing unit (GPU), and a neural processing unit (NPU), but are not limited to the examples of the processor 140 described above.

The CPU is a general-purpose processor 140 capable of performing not only general operations but also artificial intelligence operations, and may efficiently execute complex programs through a multi-layer cache structure. The CPU is advantageous in a serial processing method that enables organic linking of previous and subsequent calculation results through sequential calculations. Except when specifically referred to as the CPU described above, the general-purpose processor 140 is not limited to the examples described above.

The GPU is the processor 140 for large-scale computations, such as floating-point operations used in graphics processing, and integrates a large number of cores to perform large-scale computations in parallel. In particular, the GPU may be advantageous over CPUs for parallel processing methods, such as convolution operations. Furthermore, the GPU may be used as coprocessors 140 to supplement the functions of the CPU. Except when specifically referred to as the GPU described above, the processor 140 for large-scale computations is not limited to the examples described above.

The NPU is the processor 140 specialized for artificial intelligence computations using the artificial neural network, and may implement each layer of the artificial neural network in hardware (e.g., silicon). In this case, since the NPU is designed to be specialized according to the specifications required by the manufacturer, the NPU has less flexibility compared to the CPU or GPU, but may efficiently process the artificial intelligence operations required by the manufacturer. Meanwhile, the NPU is the processor 140 specialized for the artificial intelligence operations, and may be implemented in various forms, such as a tensor processing unit (TPU), an intelligence processing unit (IPU), and a vision processing unit (VPU). Except when specifically referred to as the NPU described above, the AI processor 140 is not limited to the examples described above.

In addition, the one or more processors 140 may be implemented as a system on chip (SoC). In this case, the SoC may further include the memory 130, and the network interface, such as a bus for the data communication between the processor 140 and the memory 130, in addition to the one or more processors 130.

When the system on chip (SoC) included in the robotic vacuum cleaner 100 includes the plurality of processors 140, the robotic vacuum cleaner 100 may use some of the processors 140 to perform the AI-related operations (e.g., operations related to AI model learning or inference). For example, the robotic vacuum cleaner 100 may use at least one of the GPU, NPU, VPU, TPU, or hardware accelerator specialized for AI operations, such as a convolution operation or a matrix multiplication operation, among the plurality of processors 140. However, this is merely an example, and it is understood that the AI-related operations may be processed using the CPU or other general-purpose processor 140.

In addition, the robotic vacuum cleaner 100 may use a plurality of cores (e.g., dual cores, quad cores, etc.) included in the single processor 140 to perform the operations related to the AI-related functions. In particular, the robotic vacuum cleaner 100 may perform the artificial intelligence operations such as the convolution operations and the matrix multiplication operations in parallel using the multi-core included in the processor 140.

One or more processors 140 control the processing of the input data according to the predefined operation rule or the AI model stored in the memory 130. The predefined operation rule or the AI model is characterized by being made through learning.

Here, being created through learning means that a predefined motion rule or an artificial intelligence model of a desired characteristic is created by applying a learning algorithm to a plurality of training data. Such learning may be made in the device itself in which the AI according to the present disclosure is performed, or may be made through a separate server/system.

The AI model may include a plurality of neural network layers. At least one layer has at least one weight value, and an operation of the layers is performed based on an operation result of a previous layer and at least one defined operation. Examples of neural networks may include a convolutional neural network (CNN), a deep neural network (DNN), a recurrent neural network (RNN), a restricted Boltzmann machine (RBM), a deep belief network (DBN), a bidirectional recurrent deep neural network (BRDNN), deep Q-networks, and a transformer, and in the present disclosure, unless otherwise specified, the neural networks are not limited to the foregoing examples.

The learning algorithm is a method of training a target device (e.g., a robot) using a plurality of pieces of training data so that the predetermined target device may make decisions or predictions on its own. Examples of the learning algorithms include supervised learning, unsupervised learning, semi-supervised learning, or reinforcement learning, but in the present disclosure, unless otherwise specified, the learning algorithm is not limited to the foregoing examples.

The machine-readable storage medium may be provided in a form of a non-transitory storage medium. Here, the term ‘non-transitory storage medium’ means a tangible storage device that does not include a signal (for example, electromagnetic waves), and the term does not distinguish between cases where data is stored semi-permanently or temporarily on a storage medium. For example, the “non-transitory storage medium” may include a buffer in which data is temporarily stored.

According to an embodiment, the methods according to the diverse embodiments disclosed in the present document may be included and provided in a computer program product. The computer program product may be traded as a product between a seller and a purchaser. The computer program product may be distributed in the form of a machine-readable storage medium (for example, compact disc read only memory (CD-ROM)), or may be distributed (for example, download or upload) through an application store (for example, Play Store™) or may be directly distributed (for example, download or upload) between two user devices (for example, smart phones) online. In a case of the online distribution, at least some of the computer program products (for example, downloadable app) may be at least temporarily stored in a machine-readable storage medium such as the memory 130 of a server of a manufacturer, a server of an application store, or a relay server or be temporarily created.

Each of components (for example, modules or programs) according to various embodiments of the present disclosure as described above may include a single entity or a plurality of entities, and some of the corresponding sub-components described above may be omitted or other sub-components may be further included in the diverse embodiments. Alternatively or additionally, some components (e.g., modules or programs) may be integrated into one entity and perform the same or similar functions performed by each corresponding component prior to integration.

Operations performed by the modules, the programs, or the other components according to the diverse embodiments may be executed in a sequential manner, a parallel manner, an iterative manner, or a heuristic manner, at least some of the operations may be performed in a different order or be omitted, or other operations may be added.

Meanwhile, terms “~er/or” or “module” used in the present disclosure may include units configured by hardware, software, or firmware, and may be used compatibly with terms such as, for example, logics, logic blocks, components, circuits, or the like. The “unit” or “module” may be an integrally configured component or a minimum unit performing one or more functions or a part thereof. For example, the module may be configured by an application-specific integrated circuit (ASIC).

Various embodiments of the present disclosure may be implemented by software including instructions stored in a machine-readable storage medium (for example, a computer-readable storage medium). A machine may be a device that invokes the stored instruction from the storage medium and may be operated depending on the invoked instruction, and may include the electronic device (for example, the robotic vacuum cleaner 100) according to the disclosed embodiments.

When a command is executed by the processor, the processor may directly perform a function corresponding to the command or other components may perform the function corresponding to the command under a control of the processor. The command may include codes created or executed by a compiler or an interpreter.

Although embodiments of the present disclosure have been illustrated and described hereinabove, the present disclosure is not limited to the abovementioned specific embodiments, but may be variously modified by those skilled in the art to which the present disclosure pertains without departing from the gist of the present disclosure as disclosed in the accompanying claims. These modifications should also be understood to fall within the scope and spirit of the present disclosure.

1. A robotic vacuum cleaner, comprising:
a first sensor using ultrasonic waves;
at least one second sensor to sense a movement of the robotic vacuum cleaner;
memory to store information corresponding to a traveling path of the robotic vacuum cleaner; and
a processor configured to:
based on the robotic vacuum cleaner moving along the traveling path, obtain first data corresponding to a feature of a floor surface through the first sensor and second data corresponding to the movement of the robotic vacuum cleaner through the at least one second sensor, and
based on a traveling data set including at least part of the first data or the second data, control an operation of the robotic vacuum cleaner.

2. The robotic vacuum cleaner as claimed in claim 1, wherein the at least one second sensor includes at least one of an acceleration sensor, an angular velocity sensor, or a wheel sensor, and
the processor is configured to:
based on the traveling data set, obtain type information including at least one of information on whether carpet is present on the floor surface along the traveling path, information on a material of the floor surface, or information on a material of the carpet,
based on the type information, control the operation of the robotic vacuum cleaner.

3. The robotic vacuum cleaner as claimed in claim 1, wherein the processor is configured to,
based on the first data corresponding to that a carpet is present on the floor surface, control the operation of the robotic vacuum cleaner corresponding to the carpet, and
based on the first data corresponding to that no carpet is present on the floor surface, control the operation of the robotic vacuum cleaner corresponding to the second data.

4. The robotic vacuum cleaner as claimed in claim 1, wherein the processor is configured to:
identify data corresponding to shaking of the robotic vacuum cleaner in the second data,
based on a value indicating an amount of change in the data and the traveling data set, identify type information corresponding to the floor surface, and
based on the type information, control the operation of the robotic vacuum cleaner.

5. The robotic vacuum cleaner as claimed in claim 4, further comprising:
at least one third sensor using infrared rays,
wherein the processor is configured to:
obtain, through the at least one third sensor, third data corresponding to reflectivity of the floor surface based on the infrared rays,
based on the value being greater than or equal to a first threshold value and a value indicating an amount of change in the third data being greater than or equal to a second threshold value, include the third data into the traveling data set.

6. The robotic vacuum cleaner as claimed in claim 1, further comprising:
a wet brush; and
a driving unit including at least one motor,
wherein the processor is configured to control the driving unit to lift the wet brush corresponding to an area on which carpet is present, based on the traveling data set indicating that the carpet is present on the floor surface while performing cleaning on the floor surface using the wet brush.

7. The robotic vacuum cleaner as claimed in claim 1, further comprising:
a dry brush; and
a driving unit including at least one motor,
wherein the processor is configured to control the driving unit to increase a suction force of the robotic vacuum cleaner corresponding to an area on which carpet is present, based on the traveling data set indicating that the carpet is present on the floor surface while the robotic vacuum cleaner cleans the floor surface using the dry brush.

8. The robotic vacuum cleaner as claimed in claim 1, further comprising:
a driving unit including at least one motor,
wherein the processor is configured to modify the information on the traveling path stored in the memory based on the traveling data set, and
control the driving unit to move the robotic vacuum cleaner based on the modified information on the traveling path.

9. The robotic vacuum cleaner as claimed in claim 1, further comprising:
a wet brush; and
a driving unit including at least one motor,
wherein the processor is configured to:
based on the traveling data set indicating that a carpet of a first material is present on the floor surface while performing cleaning on the floor surface using the wet brush, control the driving unit to lift the wet brush corresponding to an area on which the carpet is present, and
based on the traveling data set indicating that a carpet of a second material different from the first material is present on the floor surface while performing cleaning of the floor surface using the wet brush, modify the information on the traveling path stored in the memory and control the driving unit to cause the robotic vacuum cleaner to travel based on the modified information on the traveling path.

10. The robotic vacuum cleaner as claimed in claim 1, further comprising:
a first wet brush disposed on a first side surface of the robotic vacuum cleaner and a second wet brush disposed on a second side surface different from the first side surface, and
a driving unit including at least one motor,
wherein the processor is configured to, based on the traveling data set indicating that there is a composite area in which a carpet is present on the floor surface corresponding to the first side surface and a carpet is not present on the floor surface corresponding to the second side surface, control the driving unit to lift the first wet brush and not to lift the second wet brush while performing cleaning on the composite area.

11. A method of controlling a robotic vacuum cleaner, the method comprising:
based on the robotic vacuum cleaner moving along a traveling path corresponding to information stored in memory, obtaining first data corresponding to a feature of a floor surface through a first sensor using ultrasonic waves and second data corresponding to movement of the robotic vacuum cleaner through at least one second sensor; and
based on a traveling data set including at least part of the first data or the second data, controlling an operation of the robotic vacuum cleaner.

12. The method as claimed in claim 11, wherein the at least one second sensor includes at least one of an acceleration sensor, an angular velocity sensor, or a wheel sensor, and
wherein the controlling of the operation of the robotic vacuum cleaner comprises:
based on the traveling data set, obtaining type information including at least one of information on whether carpet is present on the floor surface along the traveling path, information on a material of the floor surface, or information on a material of the carpet; and
based on the type information, controlling the operation of the robotic vacuum cleaner.

13. The method as claimed in claim 11, wherein the controlling of the operation of the robotic vacuum cleaner comprises:
based on the first data corresponding to that a carpet is present on the floor surface, controlling the operation of the robotic vacuum cleaner corresponding to the carpet; and
based on the first data corresponding to that no carpet is present on the floor surface, controlling the operation of the robotic vacuum cleaner corresponding to the second data.

14. The method as claimed in claim 11, further comprising:
identifying data corresponding to shaking of the robotic vacuum cleaner in the second data;
based on a value indicating an amount of change in the data and the traveling data set, identifying type information corresponding to the floor surface; and
based on the type information, controlling the operation of the robotic vacuum cleaner.

15. The method as claimed in claim 14, wherein the robotic vacuum cleaner further comprises at least one third sensor using infrared rays,
wherein the method further comprises:
obtaining, through the at least one third sensor, third data corresponding to reflectivity of the floor surface based on the infrared rays; and
based on the value being greater than or equal to a first threshold value and a value indicating an amount of change in the third data being greater than or equal to a second threshold value, including the third data into the traveling data set.

16. The method as claimed in claim 11, wherein the robotic vacuum cleaner further comprises a wet brush and a driving unit including at least one motor,
wherein the controlling of the operation of the robotic vacuum cleaner comprises:
controlling the driving unit to lift the wet brush corresponding to an area on which carpet is present, based on the traveling data set indicating that the carpet is present on the floor surface while performing cleaning on the floor surface using the wet brush.

17. The method as claimed in claim 11, wherein the robotic vacuum cleaner further comprises a dry brush and a driving unit including at least one motor,
wherein the controlling of the operation of the robotic vacuum cleaner comprises:
controlling the driving unit to increase a suction force of the robotic vacuum cleaner corresponding to an area on which carpet is present, based on the traveling data set indicating that the carpet is present on the floor surface while the robotic vacuum cleaner cleans the floor surface using the dry brush.

18. The method as claimed in claim 11, wherein the robotic vacuum cleaner further comprises a wet brush and a driving unit including at least one motor,
wherein the controlling of the operation of the robotic vacuum cleaner comprises:
based on the traveling data set indicating that a carpet of a first material is present on the floor surface while performing cleaning on the floor surface using the wet brush, controlling the driving unit to lift the wet brush corresponding to an area on which the carpet is present; and
based on the traveling data set indicating that a carpet of a second material different from the first material is present on the floor surface while performing cleaning of the floor surface using the wet brush, modifying the information on the traveling path stored in the memory and controlling the driving unit to cause the robotic vacuum cleaner to travel based on the modified information on the traveling path.

19. The method as claimed in claim 11, wherein the robotic vacuum cleaner further comprises a first wet brush disposed on a first side surface of the robotic vacuum cleaner, a second wet brush disposed on a second side surface different from the first side surface, and a driving unit including at least one motor,
wherein the controlling of the operation of the robotic vacuum cleaner comprises:
based on the traveling data set indicating that there is a composite area in which a carpet is present on the floor surface corresponding to the first side surface and a carpet is not present on the floor surface corresponding to the second side surface, controlling the driving unit to lift the first wet brush and not to lift the second wet brush while performing cleaning on the composite area.

20. A non-transitory computer-readable recording medium including a program executing a controlling method of a robotic vacuum cleaner, the controlling method comprises:
based on the robotic vacuum cleaner moving along a traveling path corresponding to information stored in memory, obtaining first data corresponding to a feature of a floor surface through a first sensor using ultrasonic waves and second data corresponding to movement of the robotic vacuum cleaner through at least one second sensor; and
based on a traveling data set including at least part of the first data or the second data, controlling an operation of the robotic vacuum cleaner.
